(19) United States
(12) Patent Application Publication
(10) Pub. No.: US 2025/0010334 A1
(43) Pub. Date: Jan. 9, 2025

(54) TACTILE SENSE PRESENTATION DEVICE AND TACTILE SENSE PRESENTATION METHOD

(71) Applicant: TDK CORPORATION, Tokyo (JP)

(72) Inventors: Kazuki SAITO, Tokyo (JP); Akira SATOH, Tokyo (JP); Kaoru KIJIMA, Tokyo (JP)

(73) Assignee: TDK CORPORATION, Tokyo (JP)

(21) Appl. No.: 18/752,854

(22) Filed: Jun. 25, 2024

(30) Foreign Application Priority Data
Jul. 3, 2023 (JP) 2023-109094

(51) Int. Cl. B06B 1/02; B06B 1/06; G06F 3/01

(52) U.S. Cl. CPC B06B 1/0269; B06B 1/0648; G06F 3/016

(57) ABSTRACT

A tactile sense presentation device includes a vibration unit including a piezoelectric element and having a resonance point in a tactile sense frequency band; and a self-oscillation circuit electrically coupled to the vibration unit, in which the piezoelectric element self-oscillates in a frequency band based on the resonance point by a drive voltage input from the self-oscillation circuit according to contact with the vibration unit.

### CROSS-REFERENCE TO RELATED APPLICATIONS

This application is based upon and claims the benefit of priority from Japanese Patent Application No. 2023-109094, filed on Jul. 3, 2023, the entire contents of which are incorporated herein by reference.

### TECHNICAL FIELD

The present disclosure relates to a tactile sense presentation device and a tactile sense presentation method.

### BACKGROUND

As a conventional tactile sense presentation device, for example, there is a device described in Japanese Unexamined Patent Publication No. H6-261738. The conventional tactile sense presentation device includes a transmission member and a tactile sense presentation unit (piezoelectric element) that generates at least one of a traveling wave and a standing wave in the transmission member. At least one of the traveling wave and the standing wave is generated in the transmission member, whereby tactile sense information of an object is transmitted to a fingertip of an operator in contact with the transmission member.

### SUMMARY

In the tactile sense presentation device, vibration using a resonance point of a piezoelectric element alone has a problem that a resonance frequency is too high to be suitable for tactile sense presentation, and it is difficult to present a tactile sense having sufficient strength.

The present disclosure has been made to solve the above problem, and an object thereof is to provide a tactile sense presentation device and a tactile sense presentation method capable of presenting a tactile sense having sufficient strength.

A tactile sense presentation device according to one aspect of the present disclosure includes: a vibration unit including a piezoelectric element and having a resonance point in a tactile sense frequency band; and a self-oscillation circuit electrically coupled to the vibration unit, in which the piezoelectric element self-oscillates in a frequency band based on the resonance point by a drive voltage input from the self-oscillation circuit according to contact with the vibration unit.

In this tactile sense presentation device, the vibration unit including the piezoelectric element has the resonance point in the tactile sense frequency band. Since the resonance point in a case where there is contact with the vibration unit is shifted to a lower frequency band than the resonance point of the piezoelectric element alone, vibration can be generated in a frequency band in which a tactile sense is more easily obtained in the piezoelectric element that self-oscillates by receiving the drive voltage from the self-oscillation circuit. Therefore, in this tactile sense presentation device, a tactile sense having sufficient strength can be presented.

The piezoelectric element may include a piezoelectric element body, a driving electrode, and a feedback electrode. According to such a configuration, the self-oscillation of the piezoelectric element using the self-oscillation circuit can be easily realized.

The vibration unit may include a diaphragm. In this case, the resonance point of the vibration unit can be easily adjusted according to the design of the piezoelectric element and the diaphragm. Therefore, in the vibration unit, vibration can be generated in a frequency band in which a tactile sense is more easily obtained.

The self-oscillation circuit may input drive voltages of a plurality of values to the piezoelectric element. In this case, it is possible to increase the variation of the presented tactile sense according to the values of the drive voltages.

An initial resonance point of the vibration unit in a case where there is no contact with the vibration unit may be 100 Hz to 500 Hz. The frequency band is a band in which a human body can easily sense a tactile sense as vibration. Therefore, by setting the initial resonance point of the vibration unit within the above range, it is possible to generate vibration in a frequency band in which a tactile sense is more easily obtained in the vibration unit.

The resonance point of the vibration unit in a case where there is contact with the vibration unit may vary on a lower frequency side than the initial resonance point. When the resonance point varies to the low frequency side, it is possible to present a clearer tactile sense.

A variation amount of the resonance point of the vibration unit in a case where there is contact with the vibration unit may increase according to a magnitude of the pressing force applied to the vibration unit. As a result, it is possible to present various tactile senses according to a state of contact with the vibration unit.

A tactile sense presentation method according to one aspect of the present disclosure is a tactile sense presentation method using a vibration unit including a piezoelectric element and having a resonance point in a tactile sense frequency band, and a self-oscillation circuit electrically coupled to the vibration unit, the method including: causing the piezoelectric element to self-oscillate in a frequency band based on the resonance point by a drive voltage input from the self-oscillation circuit according to contact with the vibration unit.

In this tactile sense presentation method, the vibration unit including the piezoelectric element has the resonance point in the tactile sense frequency band. Since the resonance point in a case where there is contact with the vibration unit is shifted to a lower frequency band than the resonance point of the piezoelectric element alone, vibration can be generated in a frequency band in which a tactile sense is more easily obtained in the piezoelectric element that self-oscillates by receiving the drive voltage from the self-oscillation circuit. Therefore, in this tactile sense presentation method, a tactile sense having sufficient strength can be presented.

### BRIEF DESCRIPTION OF THE DRAWINGS

FIG. 1 is a schematic cross-sectional diagram illustrating a tactile sense presentation device according to an embodiment of the present disclosure;

FIG. 2 is a diagram illustrating a relationship between a concave pressure on a panel layer and a variation amount of a resonance point of a vibration unit; and

FIG. 3 is a diagram illustrating a configuration example of a self-oscillation circuit applied to the tactile sense presentation device illustrated in FIG. 1.

### DETAILED DESCRIPTION

Hereinafter, preferred embodiments of a tactile sense presentation device and a tactile sense presentation method according to one aspect of the present disclosure will be described in detail with reference to the drawings.

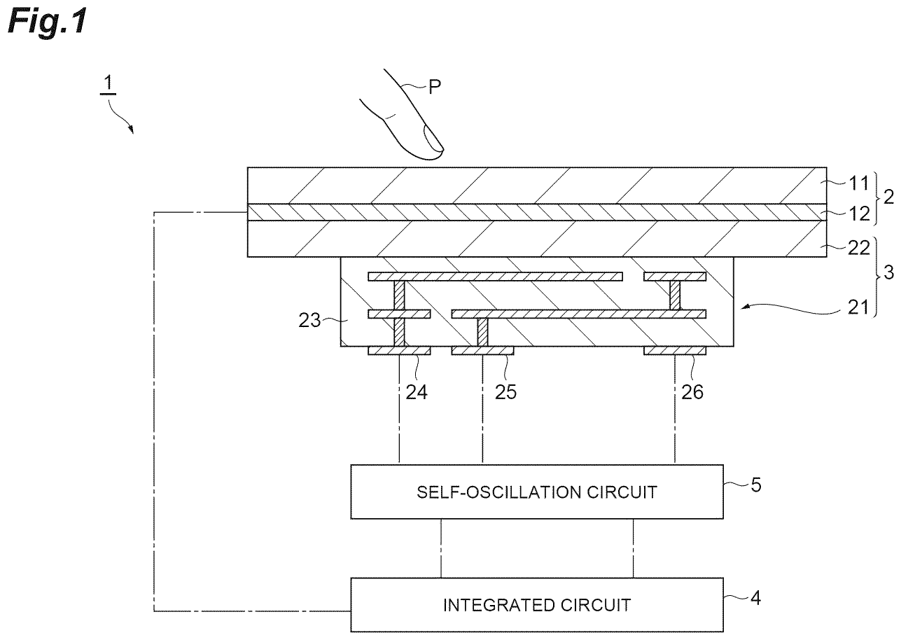

FIG. 1 is a schematic cross-sectional diagram illustrating a tactile sense presentation device according to an embodiment of the present disclosure. A tactile sense presentation device 1 illustrated in FIG. 1 is a device that presents vibration according to contact of a finger or the like as a tactile sense, and can be mounted on an electronic device such as a smartphone, a tablet, or a navigation device. As illustrated in FIG. 1, the tactile sense presentation device 1 includes a touch panel 2, a vibration unit 3, an integrated circuit 4, and a self-oscillation circuit 5.

The touch panel 2 includes, for example, a panel layer 11 formed of glass or the like, an electrostatic sensor 12 provided on a back surface side of the panel layer 11, and the like. The electrostatic sensor 12 is electrically coupled to the integrated circuit 4 by a wiring member (not illustrated). The electrostatic sensor 12 detects a change in capacitance of the panel layer 11 in response to contact of a finger P or the like with the panel layer 11, and outputs a signal indicating a detection result to the integrated circuit 4.

The vibration unit 3 is a unit that includes a piezoelectric element 21, and vibrates at a predetermined resonance point. In the present embodiment, the vibration unit 3 includes a diaphragm 22 and a piezoelectric element 21. The diaphragm 22 is a plate-like member made of, for example, a Ni—Fe alloy, Ni, brass, stainless steel, or the like. The touch panel 2 is fixed to one surface side of the vibration unit 3, and the piezoelectric element 21 is fixed to the other surface side of the vibration unit 3.

The vibration unit 3 has a resonance point in a tactile sense frequency band. The tactile sense frequency band is, for example, a frequency band in which vibration can be sensed as a tactile sense by a human fingertip, and is, for example, 100 Hz to 500 Hz. The resonance point of the vibration unit 3 can be designed by a material, a shape, and a dimension of the piezoelectric element 21 configuring the vibration unit 3, a thickness of the piezoelectric layer, a number of laminated piezoelectric layers, and the like.

In the present embodiment, the diaphragm 22 and the panel layer 11 are fixed to the piezoelectric element 21. Therefore, for example, the resonance point can be adjusted by adjusting the thickness of the diaphragm 22 and the thickness of the panel layer 11 in addition to the thickness of the piezoelectric element 21. When the thickness of the diaphragm 22 and the thickness of the panel layer 11 are increased, an initial resonance point in a case where there is no contact with the vibration unit 3 (contact of a finger with the panel layer 11) can be shifted to a high frequency side. When the thickness of the diaphragm 22 and the thickness of the panel layer 11 are increased, the initial resonance point in a case where there is no contact with the vibration unit 3 can be shifted to the low frequency side.

In the present embodiment, the vibration unit 3 is designed such that the initial resonance point in a case where there is no contact with the vibration unit 3 is, for example, 100 Hz to 500 Hz, preferably 100 Hz to 200 Hz, which is the tactile sense frequency band. Further, the vibration unit 3 is designed such that a variation resonance point (resonance point after variation from the initial resonance point) of the vibration unit 3 in a case where there is contact with the vibration unit 3 is 50 Hz to 250 Hz, preferably 50 Hz to 200 Hz.

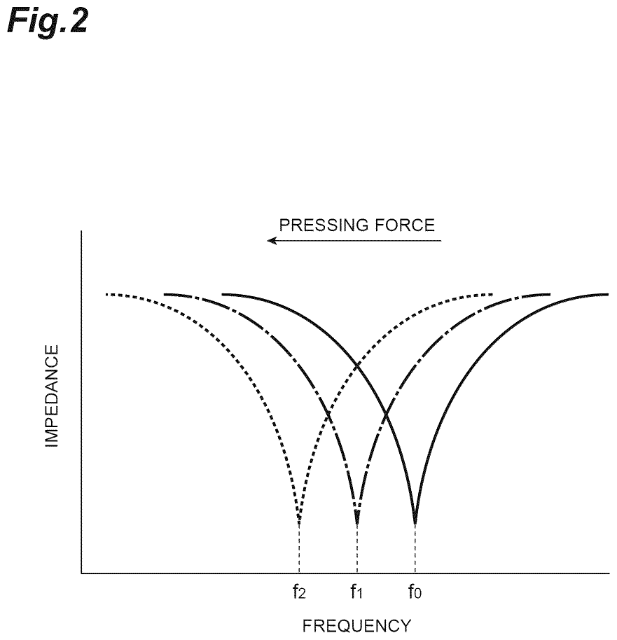

As illustrated in FIG. 2, the variation resonance point of the vibration unit 3 in a case where there is contact with the vibration unit 3 varies on the lower frequency side than an initial resonance point f0, and the variation amount increases according to a magnitude of the pressing force applied to the vibration unit 3. A variation resonance point f1 when the pressing force is small becomes smaller than the initial resonance point f0, and the vibration unit 3 presents the finger with a tactile sense due to weak vibration. A variation resonance point f2 when the pressing force is large becomes smaller than the variation resonance point f1, and the vibration unit 3 presents the finger with a tactile sense by strong vibration as compared with the case where the pressing force is small.

The piezoelectric element 21 has a rectangular parallelepiped shape that is flat in a thickness direction. The rectangular parallelepiped shape may also include a shape in which corner portions and ridge portions are chamfered and a shape in which corner portions and ridge portions are rounded. The piezoelectric element 21 has a piezoelectric element body 23, a main electrode (driving electrode) 24, a ground electrode (driving electrode) 25, and a feedback electrode 26. Each of the main electrode 24, the ground electrode 25, and the feedback electrode 26 is configured by electrically coupling an internal electrode formed in a predetermined pattern inside the piezoelectric element body 23 and an external electrode formed in a predetermined pattern on an outer surface of the piezoelectric element body 23 with a through-hole.

The piezoelectric element body 23 is configured by laminating a plurality of piezoelectric layers. Each piezoelectric layer is made of a piezoelectric material such as a piezoelectric ceramic, and is alternately laminated with the internal electrode. Examples of the piezoelectric ceramic material include PZT[Pb(Zr, Ti)O₃], PT(PbTiO₃), PLZT[(Pb, La)(Zr, Ti)O₃], barium titanate (BaTiO₃), and the like.

Each piezoelectric layer is configured by, for example, a sintered body of a ceramic green sheet including the above-described piezoelectric ceramic. In the actual piezoelectric element body 23, the piezoelectric layers are integrated to such an extent that boundaries between the piezoelectric layers cannot be recognized. The internal electrode and the external electrode are made of a conductive material. Examples of the conductive material include Ag, Pd, an Ag—Pd alloy, and the like. The internal electrode and the external electrode are configured by, for example, a sintered body of a conductive paste including the above-described conductive material.

A wiring member (not illustrated) is used for electrical coupling between the piezoelectric element 21 and an external device. As the wiring member, for example, a flexible printed circuit board (FPC) is used. One end of the wiring member is electrically coupled to each of the main electrode 24, the ground electrode 25, and the feedback electrode 26 of the piezoelectric element 21. For coupling these electrodes and the wiring member, for example, an anisotropic conductive adhesive can be used. The other end of the wiring member is drawn out from the piezoelectric element 21 and electrically coupled to the self-oscillation circuit 5.

The integrated circuit 4 is a circuit that generates a DC voltage (drive voltage) toward the piezoelectric element 21. The integrated circuit 4 is electrically coupled to the electrostatic sensor 12 and the self-oscillation circuit 5 by a wiring member (not illustrated). When receiving a signal indicating a detection result of a change in capacitance of the panel layer 11 from the electrostatic sensor 12, the integrated circuit 4 generates a DC voltage and inputs the DC voltage to the self-oscillation circuit 5.

The DC voltage input from the integrated circuit 4 to the self-oscillation circuit 5 may be constant regardless of the amount of change in the capacitance of the panel layer 11. In this case, the integrated circuit 4 can be constructed at low cost by setting the DC voltage to a relatively small value of, for example, about several volts.

The DC voltage input from the integrated circuit 4 to the self-oscillation circuit 5 may take a plurality of values. For example, the first 0.1 ms may be set to 3 V, and the subsequent 0.1 ms may be set to 5 V. In a case where the DC voltage takes a plurality of values, periods for taking the respective values may be different from each other. For example, the first 0.2 ms may be set to 3 V, the subsequent 0.1 ms may be set to 4 V, and the further subsequent 0.5 ms may be set to 5 V. In these cases, it is possible to change the added intensity of the vibration in the vibration unit 3 with respect to a certain contact, and it is possible to increase the variation of a tactile sense to be presented.

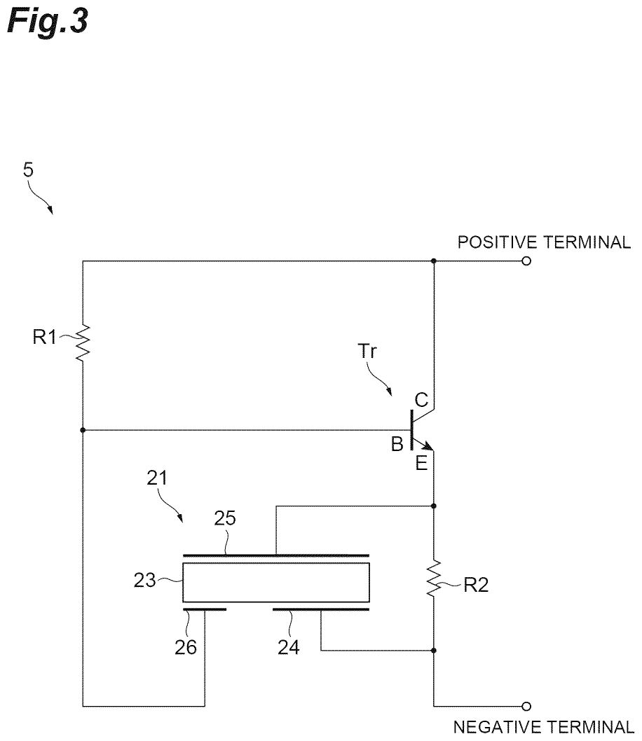

The self-oscillation circuit 5 is a circuit that causes the piezoelectric element 21 to self-oscillate in a frequency band based on a resonance point. As illustrated in FIG. 3, the self-oscillation circuit 5 includes resistors R1 and R2 and a transistor Tr, and is electrically coupled to each of the main electrode 24, the ground electrode 25, and the feedback electrode 26 of the piezoelectric element 21 and the integrated circuit 4. The values of the resistors R1 and R2 are appropriately designed according to the configuration of the vibration unit 3 or the like. In the present embodiment, the resistor R1 is, for example, 100 kΩ, and the resistor R2 is, for example, 750Ω. When the DC voltage from the integrated circuit 4 is applied between a positive terminal and a negative terminal, the piezoelectric element 21 is immediately charged. Then, a base current flows to the transistor Tr through the resistor R1, and the transistor Tr is turned on.

When the transistor Tr is turned on, a discharge current starts to flow between the main electrode 24 and the ground electrode 25 of the piezoelectric element 21 through the resistor R2. As a result, a positive voltage is induced in the feedback electrode 26, and the voltage is applied to the base voltage of the transistor Tr, so that the on state of the transistor Tr continues. Thereafter, when the discharge current between the main electrode 24 and the ground electrode 25 of the piezoelectric element 21 decreases and the voltage induced in the feedback electrode 26 becomes equal to or lower than a base-emitter saturation voltage of the transistor Tr, the transistor Tr is turned off.

When the transistor Tr is turned off, a charging current starts to flow between the main electrode 24 and the ground electrode 25 of the piezoelectric element 21 through the resistor R2. As a result, a negative voltage is induced in the feedback electrode 26, and the base voltage of the transistor Tr further decreases, so that the off state of the transistor Tr continues. Thereafter, when the charging current between the main electrode 24 and the ground electrode 25 of the piezoelectric element 21 decreases and the voltage induced in the feedback electrode 26 exceeds the base-emitter saturation voltage of the transistor Tr, the transistor Tr is turned on again. Thereafter, in the piezoelectric element 21, the above-described charge/discharge operation is repeatedly executed, so that the piezoelectric element 21 continuously performs sounding oscillation in a frequency band based on the resonance point.

As described above, in the tactile sense presentation device 1 and the tactile sense presentation method, the vibration unit 3 including the piezoelectric element 21 has a resonance point in the tactile sense frequency band. Since the resonance point in a case where there is contact with the vibration unit 3 is shifted to a lower frequency band than the resonance point of the piezoelectric element 21 alone, vibration can be generated in a frequency band in which a tactile sense is more easily obtained in the piezoelectric element 21 that self-oscillates by receiving the drive voltage from the self-oscillation circuit 5. Therefore, in the tactile sense presentation device 1 and the tactile sense presentation method, a tactile sense having sufficient strength can be presented.

In the present embodiment, the piezoelectric element 21 includes the piezoelectric element body 23, the driving electrode (main electrode 24 and ground electrode 25), and the feedback electrode 26. According to such a configuration, the self-oscillation of the piezoelectric element 21 using the self-oscillation circuit 5 can be easily realized.

In the present embodiment, the vibration unit 3 includes the diaphragm 22. In this case, the resonance point of the vibration unit 3 can be easily adjusted according to the design of the piezoelectric element 21 and the diaphragm 22. Therefore, in the vibration unit 3, vibration can be generated in a frequency band in which a tactile sense is more easily obtained.

In the present embodiment, the self-oscillation circuit 5 inputs the drive voltages of the plurality of values to the piezoelectric element 21. In this case, it is possible to increase the variation of the presented tactile sense according to the values of the drive voltages.

In the present embodiment, the initial resonance point f0 of the vibration unit 3 in a case where there is no contact with the vibration unit 3 is 100 Hz to 500 Hz. The frequency band is a band in which a human body can easily sense a tactile sense as vibration. Therefore, by setting the initial resonance point of the vibration unit 3 within the above range, it is possible to generate vibration in a frequency band in which a tactile sense is more easily obtained in the vibration unit 3.

In the present embodiment, the resonance point (variation resonance points f1 and f2) of the vibration unit 3 in a case where there is contact with the vibration unit 3 varies on the lower frequency side than the initial resonance point f0. When the resonance point varies to the low frequency side, it is possible to present a clearer tactile sense.

In the present embodiment, the variation amount of the resonance point of the vibration unit 3 in a case where there is contact with the vibration unit 3 increases according to the magnitude of the pressing force applied to the vibration unit 3. That is, in the present embodiment, the variation resonance point f1 when the pressing force is small is smaller than the initial resonance point f0, and the variation resonance point f2 when the pressing force is large is smaller than the variation resonance point f1. Therefore, it is possible to present various tactile senses according to the state of contact with the vibration unit 3.

What is claimed is:

1. A tactile sense presentation device comprising:
a vibration unit including a piezoelectric element and having a resonance point in a tactile sense frequency band; and
a self-oscillation circuit electrically coupled to the vibration unit, wherein
the piezoelectric element self-oscillates in a frequency band based on the resonance point by a drive voltage input from the self-oscillation circuit according to contact with the vibration unit.

2. The tactile sense presentation device according to claim 1, wherein the piezoelectric element includes a piezoelectric element body, a driving electrode, and a feedback electrode.

3. The tactile sense presentation device according to claim 1, wherein the vibration unit includes a diaphragm.

4. The tactile sense presentation device according to claim 1, wherein the self-oscillation circuit inputs drive voltages of a plurality of values to the piezoelectric element.

5. The tactile sense presentation device according to claim 1, wherein an initial resonance point of the vibration unit in a case where there is no contact with the vibration unit is 100 Hz to 500 Hz.

6. The tactile sense presentation device according to claim 5, wherein a resonance point of the vibration unit in a case where there is contact with the vibration unit varies on a lower frequency side than the initial resonance point.

7. The tactile sense presentation device according to claim 6, wherein a variation amount of the resonance point of the vibration unit in a case where there is contact with the vibration unit increases according to a magnitude of a pressing force applied to the vibration unit.

8. A tactile sense presentation method using
a vibration unit including a piezoelectric element and having a resonance point in a tactile sense frequency band, and
a self-oscillation circuit electrically coupled to the vibration unit, the method comprising:
causing the piezoelectric element to self-oscillate in a frequency band based on the resonance point by a drive voltage input from the self-oscillation circuit according to contact with the vibration unit.
